(19) United States
(12) Patent Application Publication
(10) Pub. No.: US 2022/0258819 A1
(43) Pub. Date: Aug. 18, 2022

(54) MOVEABLE SUBFRAME SYSTEM, A SLIDER BOX IMPROVEMENT SYSTEM, AND METHODS OF USE

(71) Applicant: Denis Cowley, Amarillo, TX (US)

(72) Inventor: Denis Cowley, Amarillo, TX (US)

(21) Appl. No.: 17/585,717

(22) Filed: Jan. 27, 2022

Related U.S. Application Data
(60) Provisional application No. 63/148,846, filed on Feb. 12, 2021.

(51) Int. Cl. B62D 63/06; B62D 63/08; B60G 21/00

(52) U.S. Cl. CPC B62D 63/061; B60G 21/00; B62D 63/08

(57) ABSTRACT

A moveable subframe system, a slider box improvement system, and methods of use are presented. The present disclosure provides the state of the art with a safer, easier to use slider box system. The present disclosure relates generally to a moveable subframe system, a slider box improvement system, and methods of use. The disclosure is a device which relates generally to subframes for heavy-duty vehicles, such as tractor trailers. The disclosure is directed to a moveable subframe for tractor-trailers which makes moving the tandem wheelsets forward and backwards easier and more efficient, especially in heavy loaded circumstances. More specifically, and without limitation, the present disclosure may be used to move and/or shift heavy applications. The disclosure provides a slider box system that enables an operator to easily move and/or adjust the location of the trailer and/or trailer load relative to the axle and/or axles.

### CROSS-REFERENCE TO RELATED APPLICATIONS

The present application claims priority to the U.S. Provisional Patent Application No. 63/148,846 which was filed on Feb. 12, 2021, which is hereby incorporated by reference herein in its entirety, including any figures, tables, or drawings.

### FIELD OF THE DISCLOSURE

The present disclosure relates generally to a moveable subframe system, a slider box improvement system, and methods of use. More specifically, and without limitation, the present disclosure is a device which relates generally to subframes for heavy-duty vehicles, such as tractor trailers. More specifically, and without limitation, the present disclosure is directed to a moveable subframe for tractor-trailers which makes moving the tandem wheelsets forward and backwards easier and more efficient, especially in heavy loaded circumstances. More specifically, and without limitation, the present disclosure may be used to move and/or shift heavy applications. However, the present disclosure is not limited to these novel and inventive improvements, and it may further be adapted for a variety of purposes.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Copyright Denis Cowley. All rights reserved.

### BACKGROUND OF THE DISCLOSURE

Slider boxes are well known in the art, especially in tractor-trailer applications. Movable subframes, another term for slider boxes, are used in heavy-duty vehicle applications. In other words, and as most commonly found, subframes, such as slider boxes, can often be applied to tractor trailers and/or semi trucks. In this application, one or more axle and/or suspension systems usually are suspended from a single slider box and typically located at the rear of the tractor trailer.

A subframe is a structural component of a vehicle. A subframe can commonly be found in cars, semi trucks, semi truck trailers, airplanes, and other craft used in transportation and the like. Typically subframes are hidden and/or are a separate structure which forms the structural elements of a vehicle or the like on a frame and/or body. The subframe is generally bolted and/or welded to the other components of the vehicle such as the drivetrain, body, and/or other mechanics serving the vehicle purpose.

The purpose of a subframe in a vehicle is to distribute the load of the vehicle created by the mechanics, drivetrain, and/or other loads such as a semi-truck trailer load. A trailer load will often involve thousands of pounds of weight. In some cases 40,000 pounds or more can be loaded in a trailer. The purpose of the subframe in these circumstances is to enable distribution of the heavy loads.

Subframes are typically made of structural steel bolted and/or welded together which carries the load. However, various subframe assemblies and types can be found in the art. Subframes often include additional components such as axles, suspensions, suspension features, additional framing components, engines, transmissions, and more.

Semi-trailers are well known in the art. Semi-trailer is a term used, often to refer to, a trailer which has at least one axle and wheels in the back, but that is also carried by a semi or tractor in the front. Semi-trailers and/or tractor-trailers are used regularly in commerce and the like to move goods around the globe. Semi-trailers are used to move goods from dry goods to liquid goods and generally require loading at one end and then unloading at another end of a journey. Loading, traveling, and unloading a tractor-trailer often requires adjustment in the way a load is distributed. This adjustment is commonly carried out by manipulating the subframe and thus manipulating the weight distribution over the wheels of the tractor-trailer. This manipulation makes loading and/or unloading easier while also making travel safer and making roads last longer.

In order to accomplish manipulation of loads for semi-trailers during loading, traversing, and unloading and the like, semi-trailers commonly employ slider boxes. Slider boxes are a type of sub frame system that can redistribute how a load is carried and/or change the distribution of weight for a semi-trailer. A slider box is also commonly known in the art. A slider box generally has two axles and/or suspension systems. For this reason, in many general applications, the slider box might also be referred to as a tandem. Slider boxes may also be outfitted with other numbers of axles, however two is one of the more common numbers found in the art.

Slider boxes are found on the underside of a trailer frame. Generally speaking a trailer is moved forward or backward along a slider box in order to distribute or redistribute load during or after loading of the trailer. More specifically, a slider box will often need to be adjusted depending on the local, state, or national road laws. So the slider box adjustment may be made multiple times before, during, or after weight checks on a scale. Adjusting the weight not only helps comply with laws, but also helps with load distribution for efficiency and vehicle maneuvering.

Slider boxes can be nearly impossible to adjust. In fact, some others in the art have developed machines to help operators adjust “pin” settings so that machines can control the adjustment of slider boxes. Slider boxes are especially difficult to adjust and often impossible to adjust when a trailer is loaded and/or fully loaded with weight. In some cases, weight has to be removed from trailers so adjustments can be made. In these events, delay, monetary value, and other factors can cause great loss. Complicating matters further, slider boxes can be dangerous when they are difficult to operate. This can result in injury to the operator either because of the strain it takes to operate the slider box or due to slider box operation.

Thus, the present disclosure provides the state of the art with a moveable subframe system, a slider box improvement system, and methods of use that provide a slider box which enables easy operation and functionality, even when a trailer is heavily loaded, without limitation to being used in a loaded trailer format. Furthermore, the present disclosure provides the state of the art with a moveable subframe system, a slider box improvement system, and methods of use that can be operated more easily, efficiently, and safely than subframes and/or slider boxes of the present state of the art. Furthermore, the present disclosure provides for a moveable subframe system, a slider box improvement system, and methods of use that is easy to set up for an operator and is fun and simple to use, compared to the state of the art and other existing devices. Furthermore, the present disclosure provides a moveable subframe system, a slider box improvement system, and methods of use that can be retrofitted onto existing trailers, in some cases, such that the present trailers and/or slider boxes can be modified. These and other solutions and disclosures are provided herein.

### SUMMARY OF THE DISCLOSURE

The present disclosure provides the state of the art with a safer, easier to use slider box system which solves these and other problems which have been plaguing the industry. Thus, the present disclosure relates generally to a moveable subframe system, a slider box improvement system, and methods of use. More specifically, and without limitation, the present disclosure is a device which relates generally to subframes for heavy-duty vehicles, such as tractor trailers. More specifically, and without limitation, the present disclosure is directed to a moveable subframe for tractor-trailers which makes moving the tandem wheelsets forward and backwards easier and more efficient, especially in heavy loaded circumstances. More specifically, and without limitation, the present disclosure may be used to move and/or shift heavy applications.

Said another way, the present disclosure provides a slider box system that enables an operator to easily move and/or adjust the location of the trailer and/or trailer load relative to the axle and/or axles. Said another way, the present disclosure provides a slider box system that provides an easy means for adjusting the “tandem” on a tractor trailer, as well as is applicable to other subframes in other applications. Furthermore, the present disclosure provides the state of the art with a slider box system that works smoothly and efficiently even under heavy loads. Furthermore, the present disclosure provides the state of the art with a slider box improvement system that prevents weight having to be removed from a loaded trailer due to the difficulty caused in existing slider box operations. Furthermore, the present disclosure provides the state of the art with a slider box improvement system that is safe and easy to use for an operator.

However, the present disclosure is not limited to these novel and inventive improvements, and it may further be adapted for a variety of purposes.

Thus, it is a primary object of the disclosure to provide a moveable subframe system, a slider box improvement system, and method of use that improve upon the state of the art.

Another object of the disclosure is to provide a moveable subframe system, a slider box improvement system, and methods of use that are easy to use.

Yet another object of the disclosure is to provide a moveable subframe system, a slider box improvement system, and methods of use that can be adjusted quickly, relatively speaking.

Another object of the disclosure is to provide a moveable subframe system, a slider box improvement system, and methods of use that are robust.

Yet another object of the disclosure is to provide a moveable subframe system, a slider box improvement system, and methods of use that are easy to set up.

Another object of the disclosure is to provide a moveable subframe system, a slider box improvement system, and methods of use that are relatively affordable to implement.

Yet another object of the disclosure is to provide a moveable subframe system, a slider box improvement system, and methods of use that can be retro-fit into existing systems.

Another object of the disclosure is to provide a moveable subframe system, a slider box improvement system, and methods of use that provide for easier slider box adjustment.

Yet another object of the disclosure is to provide a moveable subframe system, a slider box improvement system, and methods of use that can be used repeatedly.

Another object of the disclosure is to provide a moveable subframe system, a slider box improvement system, and methods of use that are lightweight.

Yet another object of the disclosure is to provide a moveable subframe system, a slider box improvement system, and methods of use that provide a slider box with bearings.

Another object of the disclosure is to provide a moveable subframe system, a slider box improvement system, and methods of use that provide a slider box with enhanced suspension systems.

Yet another object of the disclosure is to provide a moveable subframe system, a slider box improvement system, and methods of use that increase the strength of a slider box.

Another object of the disclosure is to provide a moveable subframe system, a slider box improvement system, and methods of use that increases convenience for a user.

Yet another object of the disclosure is to provide a moveable subframe system, a slider box improvement system, and methods of use that work under various operating conditions.

Another object of the disclosure is to provide a moveable subframe system, a slider box improvement system, and methods of use that make slider box adjustments smooth and easy.

Yet another object of the disclosure is to provide a moveable subframe system, a slider box improvement system, and methods of use that do not require additional power and/or supplemental motors and the like.

Another object of the disclosure is to provide a moveable subframe system, a slider box improvement system, and methods of use that reduces the need for additional distribution operations.

Yet another object of the disclosure is to provide a moveable subframe system, a slider box improvement system, and methods of use that may utilize high strength materials.

Another object of the disclosure is to provide a moveable subframe system, a slider box improvement system, and methods of use that provide for smooth repositioning of the slider box relative to the trailer frame rails.

Yet another object of the disclosure is to provide a moveable subframe system, a slider box improvement system, and methods of use that work with an automated system.

Another object of the disclosure is to provide a moveable subframe system, a slider box improvement system, and methods of use that provide for a plurality of spinning wheels which are strong enough to support heavy loads.

Yet another object of the disclosure is to provide a moveable subframe system, a slider box improvement system, and methods of use that can be implemented in various ways to accommodate various applications.

These and other objects, features, or advantages of the present disclosure will become apparent from the specification and claims.

### BRIEF DESCRIPTION OF THE DRAWINGS

FIG. 1 is a top, perspective view of the moveable subframe system, a slider box improvement system, and methods of use; the view showing a slider box; the view showing a slider box having a plurality of members; the view showing a slider box having rail guides; the view showing a plurality of rails; the view showing a plurality of rollers.

FIG. 2 is a top, perspective view of the moveable subframe system, a slider box improvement system, and methods of use; the view showing a slider box; the view showing a slider box having a plurality of members; the view showing a slider box having rail guides; the view showing a plurality of rails; the view showing a plurality of rollers.

FIG. 3 is a bottom, perspective view of the moveable subframe system, a slider box improvement system, and methods of use; the view showing a slider box; the view showing a slider box having a plurality of members; the view showing a slider box having rail guides; the view showing a plurality of rails; the view showing a plurality of rollers; the view showing the plurality of rails engaging the plurality of rollers.

FIG. 4 is a bottom, perspective view of the moveable subframe system, a slider box improvement system, and methods of use; the view showing a slider box; the view showing a slider box having a plurality of members; the view showing a slider box having rail guides; the view showing a plurality of rails; the view showing a plurality of rollers; the view showing the plurality of rails engaging the plurality of rollers.

FIG. 5 is a top view of the moveable subframe system, a slider box improvement system, and methods of use; the view showing a slider box; the view showing a slider box having a plurality of members; the view showing a slider box having rail guides; the view showing a plurality of rails.

FIG. 6 is a bottom view of the moveable subframe system, a slider box improvement system, and methods of use; the view showing a slider box; the view showing a slider box having a plurality of members; the view showing a slider box having rail guides; the view showing a plurality of rails.

FIG. 7 is a front view of the moveable subframe system, a slider box improvement system, and methods of use; the view showing a slider box; the view showing a slider box having a plurality of members; the view showing a slider box having rail guides; the view showing a plurality of rails; the view showing a plurality of rollers; the view showing the plurality of rails engaging the plurality of rollers.

FIG. 8 is a rear view of the moveable subframe system, a slider box improvement system, and methods of use; the view showing a slider box; the view showing a slider box having a plurality of members; the view showing a slider box having rail guides; the view showing a plurality of rails; the view showing a plurality of rollers; the view showing the plurality of rails engaging the plurality of rollers.

FIG. 9 is a side view of the moveable subframe system, a slider box improvement system, and methods of use; the view showing a slider box; the view showing a slider box having a plurality of members; the view showing a slider box having rail guides; the view showing a plurality of rails; the view showing a plurality of rollers; the view showing the plurality of rails engaging the plurality of rollers.

FIG. 10 is a side view of the moveable subframe system, a slider box improvement system, and methods of use; the view showing a slider box; the view showing a slider box having a plurality of members; the view showing a slider box having rail guides; the view showing a plurality of rails; the view showing a plurality of rollers; the view showing the plurality of rails engaging the plurality of rollers.

FIG. 11 is an isometric view of the moveable subframe system, a slider box improvement system, and methods of use; the view showing a slider box; the view showing a slider box having a plurality of members; the view showing a slider box having rail guides; the view showing a plurality of rails; the view showing a plurality of rollers.

FIG. 12 is an isometric view of the moveable subframe system, a slider box improvement system, and methods of use; the view showing a slider box; the view showing a slider box having a plurality of members; the view showing a slider box having rail guides; the view showing a plurality of rails; the view showing a plurality of rollers.

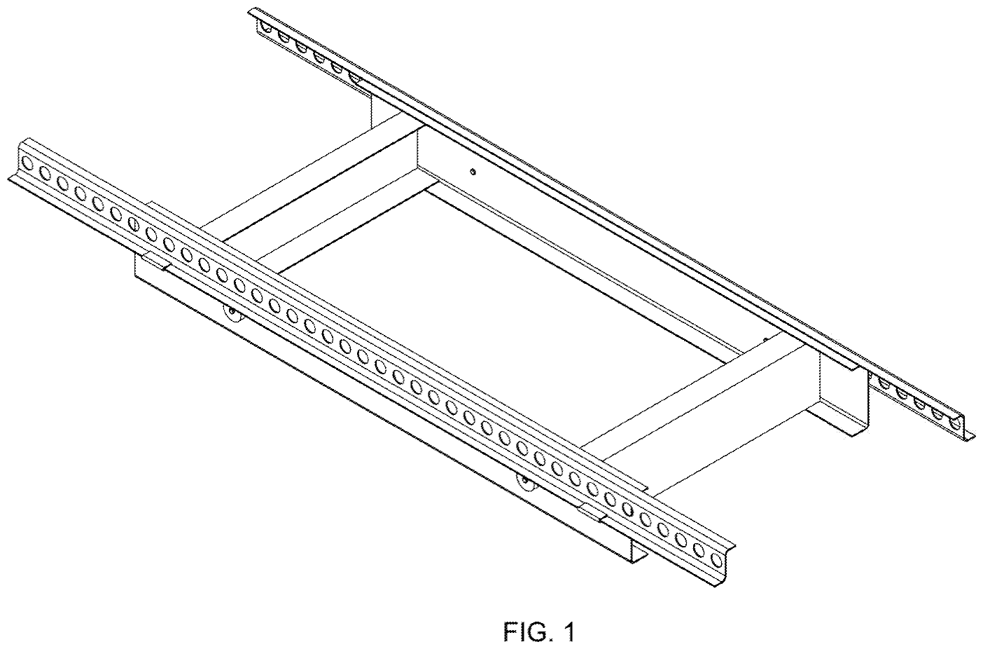

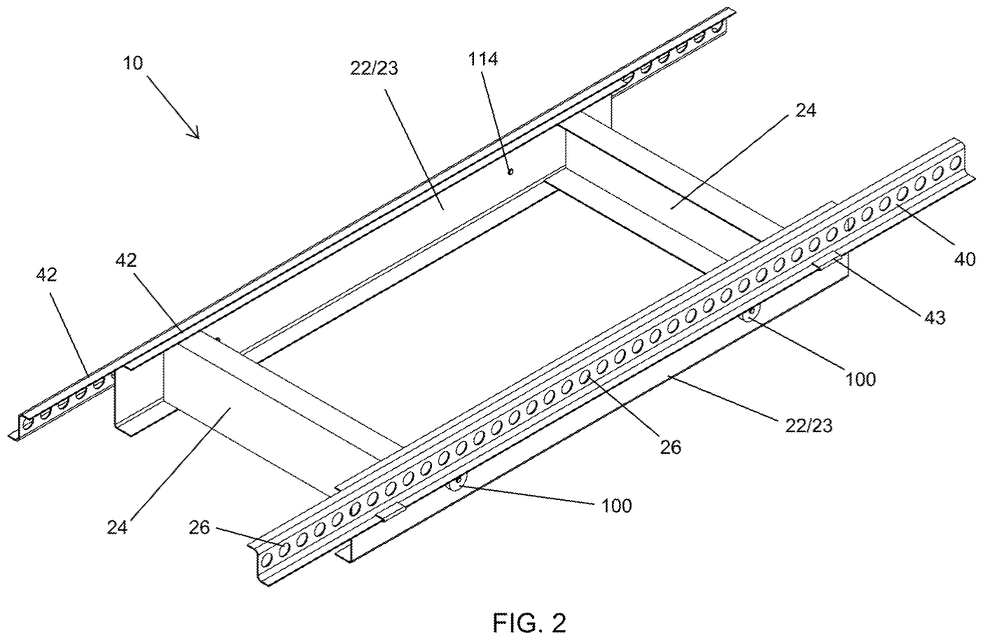

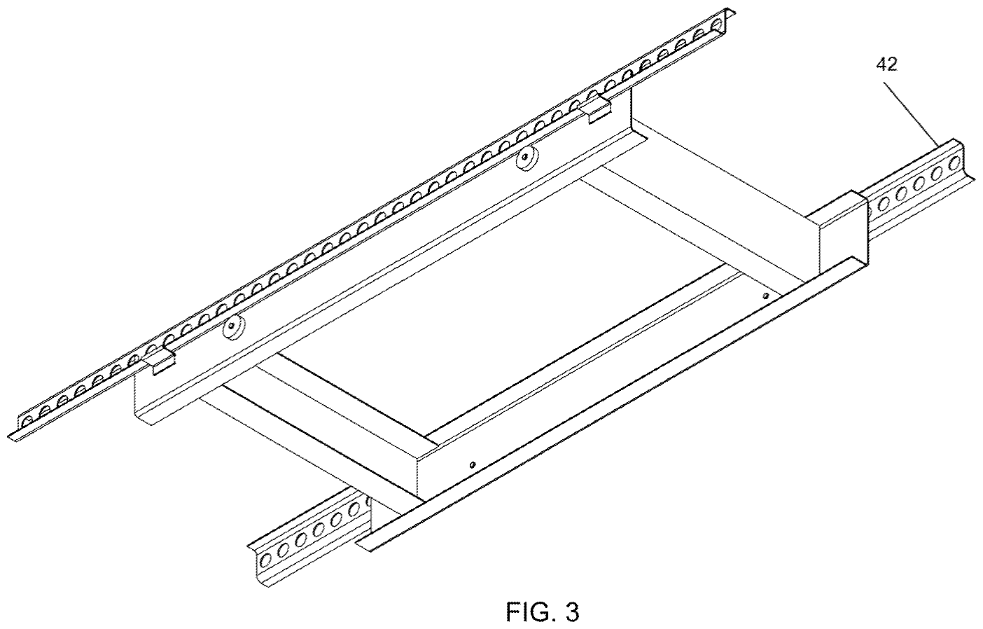

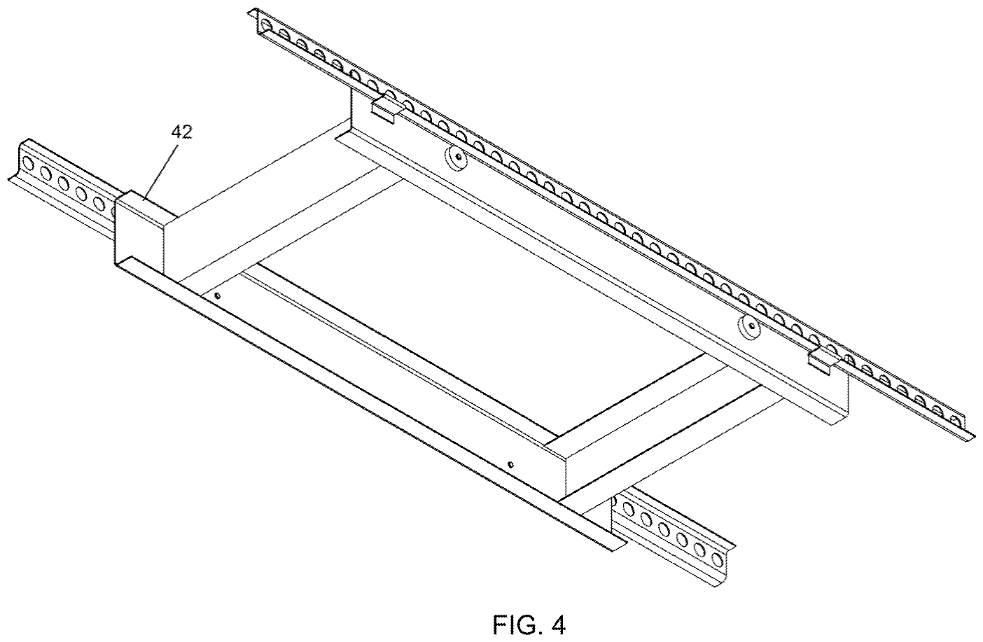

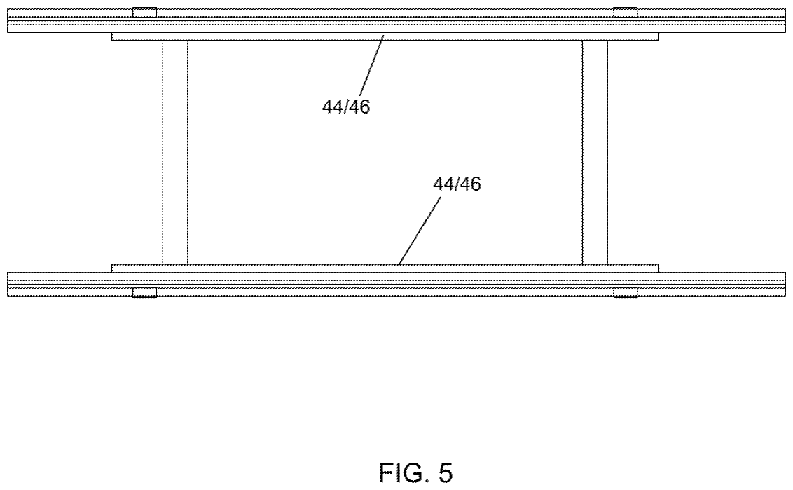

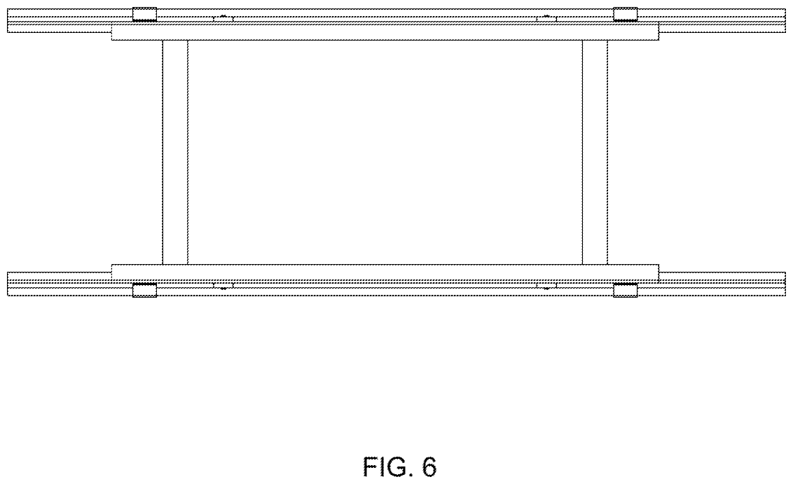

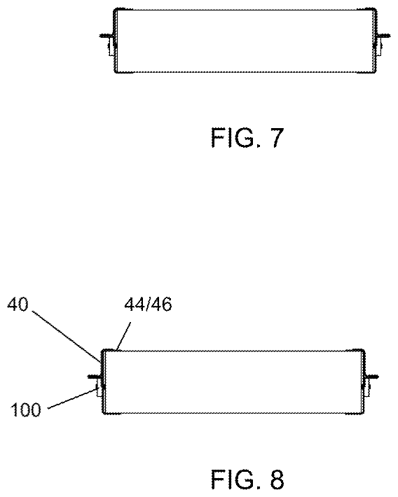

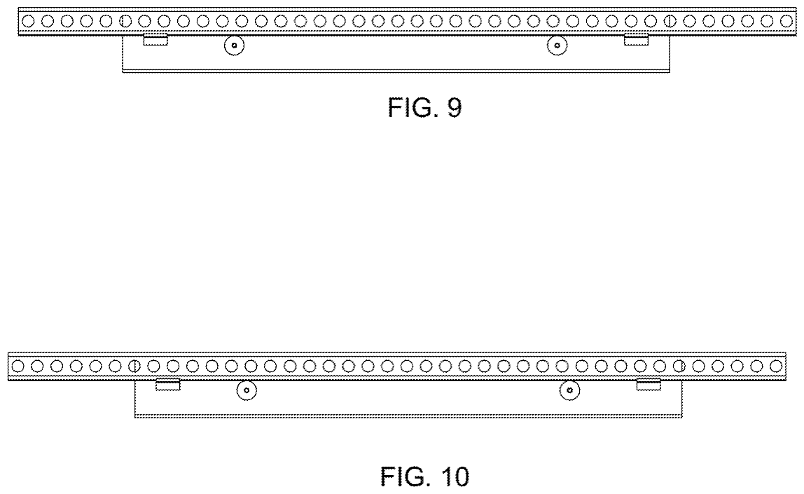

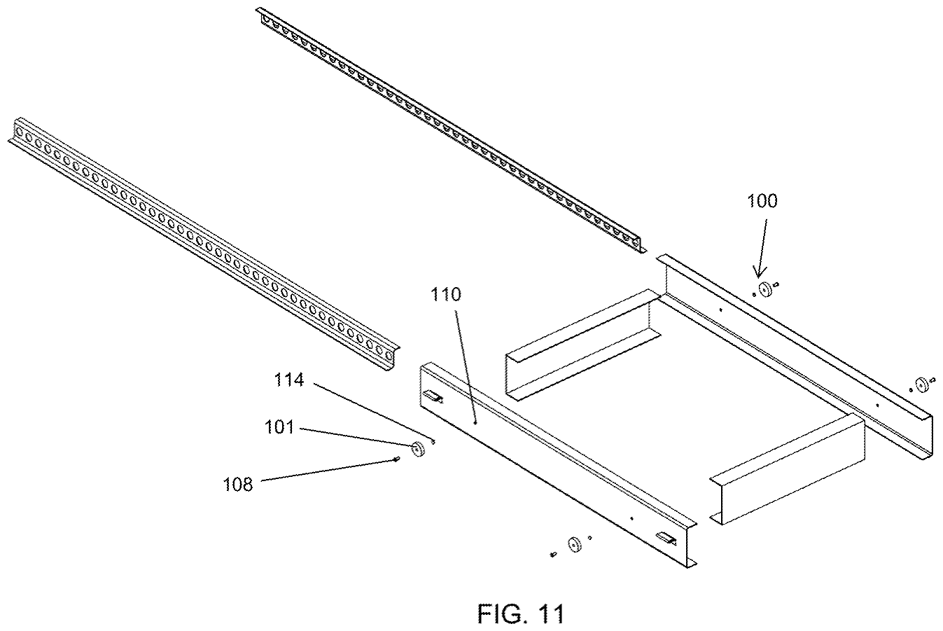

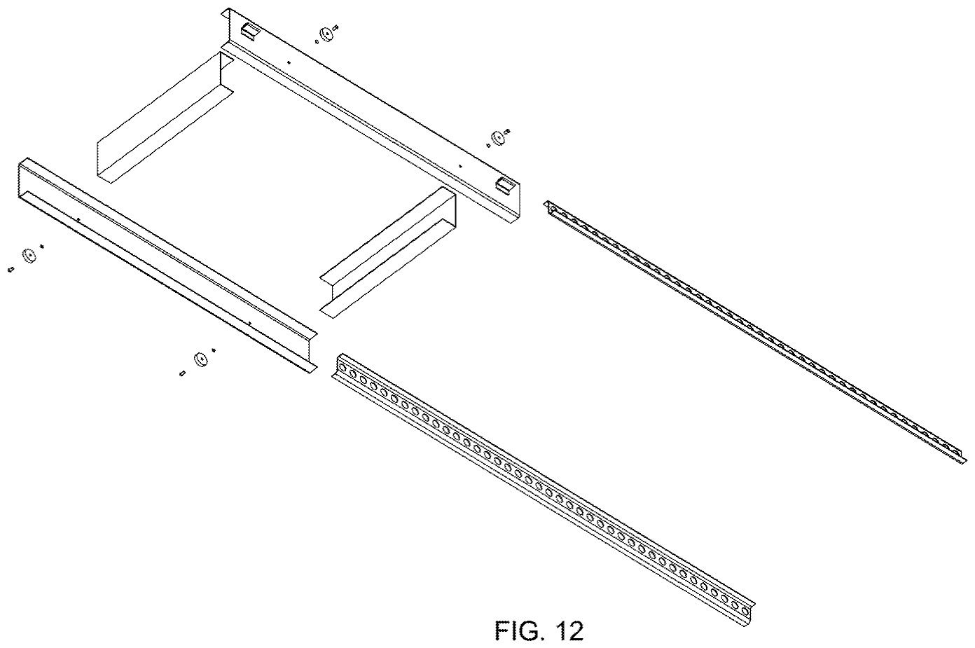

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

All illustrations of the drawings are for the purpose of describing selected versions of the present disclosure and are not intended to limit the scope of the present disclosure.

Although the disclosure has been explained in relation to its preferred embodiment, it is to be understood that many other possible modifications and variations can be made without departing from the spirit and scope of the disclosure.

System:

With reference to the figures, a moveable subframe system, a slider box improvement system, and methods of use 10 are presented (also known as “subframe system”, or “subframe slider system”, or “slider box system”, or “slider system”, or “tandem system”, or “tandem sliding system”, or simply “system”). Subframe slider system 10 is formed of any suitable size, shape and design and is configured to provide the state of the art with a safer, easier to use slider box system which solves these and other problems which have been plaguing the industry. Thus, the present disclosure relates generally to a moveable subframe system, a slider box improvement system, and methods of use. More specifically, and without limitation, the present disclosure is a device which relates generally to subframes for heavy-duty vehicles, such as tractor trailers.

More specifically, and without limitation, system 10 is directed to a moveable subframe for tractor-trailers which makes moving the tandem wheelsets forward and backwards easier and more efficient, especially in heavy loaded circumstances. More specifically, and without limitation, the present disclosure may be used to move and/or shift heavy applications.

Said another way, the system 10 provides a slider box system that enables an operator to easily move and/or adjust the location of the trailer and/or trailer load relative to the axle and/or axles. Said another way, the present disclosure provides a slider box system that provides an easy means for adjusting the “tandem” on a tractor trailer, as well as is applicable to other subframes in other applications. Furthermore, the present disclosure provides the state of the art with a slider box system that works smoothly and efficiently even under heavy loads. Furthermore, the present disclosure provides the state of the art with a slider box improvement system that prevents weight having to be removed from a loaded trailer due to the difficulty caused in existing slider box operations. Furthermore, the present disclosure provides the state of the art with a slider box improvement system that is safe and easy to use for an operator.

In the arrangement shown, as one example, system 10 may include an operator, may include a vehicle, may include a vehicle frame, and may include a vehicle frame having rails.

In the arrangement shown, as one example, system 10 includes a slider box assembly 20, a retractable pin, a plurality of rails 40, a plurality of hangers, a suspension system, may also include a plurality of wheels, includes a reinforcement system (also referred to as a suspension enhancement system), and includes a roller system 100, among other components, features, and functionality.

Operator:

In the arrangement shown, as one example, system 10 may include at least one operator. Operator (also known as a “user”) is typically a user engaging with the tandem slider system 10. Similarly, the operator may be engaging with the slider box system 10 by engaging and/or disengaging a lever (to be further discussed herein); a lever which activates a retractable pin (to be further discussed herein).

Similarly, an operator may be a plurality of operators engaging with subframe system 10. As one example, one operator may be engaging with the lever and/or standing by outside the trailer, near the subframe assembly (to be further discussed herein) while a second operator is located in the cab and/or tractor and/or truck moving the trailer forward and/or backwards to move the trailer atop the subframe assembly.

In the arrangement shown, as one example, a user is an individual or group of users engaging with the operation of the subframe assembly—whether this is manually or through the operation of a mechanical device, an automated device, or even through a graphical user interface via a computer processing unit, tablet, smartphone, and the like—and the user is engaging system 10 so that system 10 is being moved in relation to the load and/or other applicable assemblies.

Vehicle:

In the arrangement shown, as one example, system 10 may include a vehicle. Vehicle (also known as “trailer”, or “truck”, or “automotive”, or “locomotive”, or “load”) is formed of any suitable size, shape, and design and is configured as the primary object for which the subframe assembly (to be further discussed herein) is carrying.

Said another way, the subframe assembly is structurally supporting a load from a vehicular type assembly. Commonly, and in one example shown and discussed, the load comes from a trailer assembly. This trailer assembly may often be carrying additional loads through cargo, equipment, and the like.

While a trailer assembly is commonly discussed herein, for ease of reference and example, other assemblies are also hereby contemplated for use. Other assemblies may include, but are not limited to, a car, a truck, a sport utility vehicle, various trailer types, various land and/or air vehicles, other assemblies which may benefit from a slider box and/or the ability to move a load and/or redistribute including but not limited to other applications such as loaded structures and the like.

Vehicle Frame: In the arrangement shown, as one example, the system 10 and further the vehicle may also include a vehicle frame which is separate from the subframe assembly (to be further discussed herein). Vehicle frame (also known as “frame”, or “primary frame”, or “chassis”, or “trailer frame”) is formed of any suitable size, shape, and design and is configured to provide support to the vehicle of which all other components, or most components are connected to. In the arrangement shown, as one example, a trailer body will attach to a trailer frame and/or a vehicle body, and other components, will attach to a vehicle frame.

Trailer Frame Rails: In the arrangement shown, as one example, the trailer frame includes trailer frame rails. Trailer frame rails (also known as “trailer rails”) are formed of any suitable size, shape, and design and are configured to serve as the sliding rails that interact with the slider box 20 (to be further discussed herein). Said another way, the slider box 20 is repositioned relative to the trailer body as the trailer frame rails slide forward or backward along the slider box 20.

Slider Box Frame:

In the arrangement shown, as one example, system 10 includes a slider box frame 20. Slider box frame 20 (also known as “main body”, or “subframe”, or “subframe slider”, or “tandem frame”, or “tandem slider”, or simply “slider box”) is formed of any suitable size, shape, and design and is configured to provide one or more axle/suspension systems while being mounted to the underside of the trailer frame to provide a moveable longitudinally, means of varying the load distribution of a vehicle, and as one example, varying the load distribution of a trailer for a semi-truck and/or tractor trailer configuration.

Said another way, the slider box frame 20 is the primary support and/or structure of the slider box which provides for shifting weight and/or load over a plurality of axles so that an operator may abide by local, state, and/or federal road laws and regulations by distribution of a proper load. Said yet another way, equipping a vehicle and/or trailer with a slider box 20 provides an advantage for an operator because the slider box provides a means to redistribute the trailer load to accommodate legal limits and/or desired distribution for operation and maneuverability of a tractor-trailer.

In the arrangement shown, as one example, slider box frame 20 is shaped by a plurality of members 22 which are also cross supported by a plurality of cross structure 24. In this way, a square configuration and other shaped configurations can be formed which are strong and durable. In this way, the members create a structural frame. Steel is commonly used in creating a structural frame. However, other materials may also be used depending on the application and desired strength. Slider boxes 20 are known in the art in many various arrangements. Commonly slider boxes are used in semi-truck and/or tractor-trailer operations. In this example, the slider box is generally formed of a c-channel or other elongated steel which can create a structure formed of several welded and/or bolted pieces. These and other formations and materials are hereby contemplated for use in slider box construction and application.

In the arrangement shown, as one example, a slider box frame 20 suitable for a tractor-trailer application which adjusts a common tandem is described. However, this is only for example and for ease of explanation. Slider box frames 20 are formed of any suitable size, shape, or design and may have structural components and other elements which provide for various configurations in various applications. It will be appreciated by those experienced in the art that a slider box frame can be suited for many vehicle types and/or applications. Furthermore, other styles of slider box frames 20 are also hereby contemplated for use, such as those currently known in the art which can be adapted and improved by the disclosure presented herein. Furthermore, various types of slider box frames 20 might be used which accommodate different suspension types, different structure types, different pin types, different locking types and mechanisms, a combination thereof, and the like.

In the arrangement shown, as one example, slider box frame 20 may include, a plurality of main members 22 and/or a plurality of members 23, a cross structure 24 and/or a plurality of cross structure members, a plurality of pin apertures 26, a plurality of diagonal members, among among other structural components, other components and features.

Retractable Pin:

In the arrangement shown, as one example, system 10 and particularly the slider box assembly 20 includes a retractable pin. Retractable pin (also known as “locking pin” or simply “pin”) is formed of any suitable size, shape, and design and is configured and used to engage and/or disengage the slider box functionality. In other words, the retractable pin is configured and used for locking the slider box 20 in place on a primary frame and/or in place on the trailer frame.

In the arrangement shown, as one example, retractable pin is shaped as an elongated rod and/or pin and is shaped so as to slide into and out of an aperture, thereby locking and/or unlocking the slider box frame with engagement to the trailer frame. In this way, the pin is shaped so as to engage an aperture of both the trailer frame and the slider box frame so as to lock the two longitudinally in place.

In the arrangement shown, as one example, the retractable pin is formed of a strong steel so as to handle forces placed on the tractor-trailer and/or other heavy duty vehicle when in operation and in operation at high speeds during turning and other maneuvering. However, other retractable pins may be large or small and/or made of various materials so as to accommodate the functionality of the retractable pin mechanism. Retractable pin may be controlled manually by an operator who engages and/or disengages a lever and/or handle associated with and/or operably connected to the pin. Furthermore, the retractable pin may be controlled manually by an operator who engages and/or disengages the retractable pin directly. Furthermore, the retractable pin might be operated mechanically by a machine and/or automatically and/or autonomously of an operator.

In the arrangement shown, as one example, one retractable pin is shown, and may include a spring and other supporting components. However, other numbers of retractable pins may also be beneficial. In another arrangement, two retractable pins which engage opposing sides of the slider box are beneficial in the balancing of forces and the like. In another example, three retractable pins may be beneficial for securement and the like. In yet another example, four retractable pins may be beneficial and other numbers of retractable pins as applicable including but not limited to five retractable pins, six retractable pins, seven retractable pins, eight retractable pins, nine retractable pins, ten retractable pins, and other numbers of retractable pins in various arrangements.

In the arrangement shown, as one example, retractable pin may include, an automated system, a first end, a second end, an exterior surface, a locking mechanism, a handle, a lever, an activation mechanism, and a deactivation system, among other components and features.

Rails:

In the arrangement shown, as one example, system 10 and particularly the slider box assembly 20 includes a plurality of rails 40. Plurality of rails 40 (also known as “sliders” or simply “rails”) are formed of any suitable size, shape, and design and is configured to act as the primary interaction and/or guidance mechanisms between the trailer frame and/or vehicle frame and the subframe and/or slider box.

In the arrangement shown, as one example, two primary rails are used to interact and are formed of elongated steel which moves longitudinally. Other arrangements, other numbers of rails, and various materials for rails are also hereby contemplated for use.

In the arrangement shown, as one example, plurality of rails 40 may include, a set of rail guides 42, a plurality of rail clips 43, a specialized friction surface 44, and a low friction strip 45, among other components and features.

Hangers:

In the arrangement shown, as one example, system 10 and particularly the slider box assembly 20 includes a plurality of hangers. Hangers are formed of any suitable size, shape, and design and are configured to support the plurality of axles. In this way, and as one example, hangers are formed and generally shaped to extend downward from the subframe assembly 20 so that the hangers are closer to the ground. In this way, the hangers serve as a connection for the axles and/or suspension systems and the slider box frame 20.

Wheels: In the arrangement shown, as one example, system 10 may include wheels. Wheels are formed of any suitable size, shape, and design. In the arrangement shown, as one example, via a suspension system (as further described herein) and the hangers, wheels are configured to be operably connected to the slider box assembly 20 through other mechanisms such that the wheels can provide smooth transportation and/or movement. Not all configurations may have wheels.

Suspension System:

In the arrangement shown, as one example, system 10 and particularly the slider box assembly 20 includes a suspension system. Suspension system is formed of any suitable size, shape, and design and is configured to aid in the operation of the vehicle by providing suspension to the wheels and/or axles and other components. Suspension systems are well known in the art. In one example, the present disclosure provides for an enhanced suspension system which is an improvement upon the state of the art and provides for the ability and functionality of some other features and components disclosed herein.

Reinforcement Plate System:

In the arrangement shown, as one example, system 10 includes a modified suspension system with reinforcement plates. Reinforcement plates (also known as “reinforcement plate system”, “reinforced suspension system” or simply “plates”) are formed of any suitable size, shape, and design and is configured to provide enhanced support to systems existing in the art so that the subframe assembly 20 and/or suspension system are able to carry an enhance load generate on these components by the addition of a plurality of rollers and the roller system 100 (as is further described herein).

In the arrangement shown, as one example, reinforcement plates are shaped from steel plates and extend a length from a first end to a second end. The steel plates are generally formed of flattened steel and extend the length from the first end to the second end with a pair of approximately parallel extending opposing sides. In the arrangement shown, as one example, the reinforcement plates include an interior surface which is fastened to a surface of the existing system and an exterior surface. In the arrangement shown, as one example, the reinforcement plates are secured to the system through welding and/or bolting. Other attachment means are also hereby contemplated for use.

Additionally, and in the arrangement shown, as one example, the reinforcement plates include a plurality of attachment features and/or attachment apertures which provide for attachment of the roller system 100 to the reinforcement plates and/or through the reinforcement plates. Similarly, and in this way, the slider rail (discussed herein) will also include a slider rail aperture (as in the arrangement shown for example).

In this way, and in the arrangement shown, as one example, the reinforcement plate system makes the roller system 100 possible. Without configuring and figuring out how to properly reinforce and or through experimentation of failed roller systems 100, the correct location, size, shape, and design of the reinforcement system could not be determined so as to make the slider box system 20 enhanced and the functionality of other components and systems disclosed herein successful, to improve upon the state of the art. Similarly, while one reinforcement plate may accommodate certain applications, other applications may call for a plurality of reinforcement plates laid on top of one another and/or inline with one another so as to form a longer and/or wider reinforcement system.

In the arrangement shown, as one example, the reinforcement plate system includes a first end, a second end, a pair of opposing sides, an interior surface, an exterior surface, an attachment aperture, and a slider rail aperture, among other components and features.

Rollers/Bearing System:

In the arrangement shown, as one example, system 10 includes a roller system 100. Roller system 100 (also known as “bearing system”, “roller support system” or “bearing support system”) is formed of any suitable size, shape, and design and is configured to roll and/or slide a trailer frame adjacent to a slider box frame with ease and smoothness.

In the arrangement shown, as one example, a roller system 100 includes a plurality of rollers operably connected to a slider box frame which has special reinforcement features to accommodate the rollers. In this way, the rollers are operably connected to the slider box frame in such a way as to carry and/or handle load of the trailer frame. In this way, the trailer frame can roll as opposed to slide or grind along the slider box. In this system and in this way, heavily loaded trailers can smoothly move along a tandem, be easily adjusted by an operator and the like. The system disclosed in this example includes reinforcement features, attachment features, rollers, other enhancement features, and the like.

In the arrangement shown, as one example, roller support system 100 is shaped as a small wheel and/or bearing and is configured and/or operably connected in a position which allows the trailer frame to roll along the perimeter of the roller 101 (to be further discussed herein). In this way, the roller will spin about an axis located in the middle while the trailer frame makes contact with the exterior perimeter of the roller.

In the arrangement shown, as one example, roller support system 100 is formed of steel, and may also be formed of other materials. Similarly, the roller is generally formed in a circle shape when viewed from the side much like a truck or car wheel. Similarly, and in this way, the frame would slide tangentially along the surface of the roller similarly to how a wheel contacts the surface of a road.

In the arrangement shown, as one example, roller support system 100 includes a plurality of rollers 101, an attachment feature 114, and a securement feature, among other components and features.

Roller: In the arrangement shown, as one example, system 10 includes at least one roller 101. Roller 101 (also known as “bearing”) is formed of any suitable size, shape, and design and is configured to rotate about an axis, while supporting weight and/or a load caused by a trailer load or the like. In this way, the roller 101 is configured so as to translate and/or allow another contact surface to move freely and fluidly across the surface of the roller 101 while the roller 101 is spinning about an axis.

In the arrangement shown, as one example, roller 101 is shaped as a circle when viewed from the side. In the arrangement shown, as one example, the roller 101 has a similar shape to a car wheel or car tire. This is one example of a roller and bearing setup. Other configurations which use a roller which is more sphere-like in shape are also hereby contemplated for use and have shown promise in helping to cause the trailer frame to slide more effectively and efficiently across the frame of the slider box while being able to carry weight.

Similarly, in the arrangement shown, it is worth noting that the reinforcement system is configured to specifically help the roller 101 to take weight of the trailer without even a fully loaded trailer causing defamation thereto.

In the arrangement shown, as one example, system 10 includes four rollers 101. However, any other number of rollers 101 is hereby contemplated for use. Other examples of another number of rollers 101 includes, but is not limited to, a single roller 101, two rollers 101, three rollers 101, five rollers 101, six rollers 101, seven rollers 101, eight rollers 101, nine rollers 101, ten rollers 101, and more.

Furthermore, in the arrangement shown, as one example, the four rollers 101 are shown equally distanced from one another at the approximate four corners of the slider box 20. However, other locations of rollers 101, as applicable for various circumstances are also hereby contemplated for use.

In the arrangement shown, as one example, roller 101 extends a length from a first end to a second end, having a circular perimeter, and may also include a bearing 108, and may also include an aperture 110, and may also include a hollow interior, among other components and features.

In Operation/Methods of Use:

In the arrangement shown, as one example, a user can easily and efficiently employ the systems disclosed herein in various methods and uses to safely, easily, and efficiently operate a slider box. These systems and the various uses are hereby contemplated for use. The disclosure herein also considered methods of using these systems and features.

Additionally, and in alternative embodiments the slider box system may be used with other systems, vehicle types and the like, and may incorporate other systems therein.

It will be appreciated by those skilled in the art that other various modifications could be made to the systems without parting from the spirit and scope of this disclosure. All such modifications and changes fall within the scope of the claims and are intended to be covered thereby.

What is claimed:

1. A frame system for shifting loads, comprising:
a slider box;
the slider box having a framing system extending a length from a first end to a second;
a plurality of rails;
wherein the plurality of rails engage the slider box;
a plurality of rollers;
the plurality of rollers is operably connected to the slider box;
wherein the plurality of rollers engage the plurality of rails such that the plurality of rollers cause the rails to slide more efficiently across the slider box;
a locking mechanism;
the locking mechanism having an activation mechanism;
wherein the activation mechanism causes the locking mechanism of the slider box to be engaged to prevent sliding of the slider box relative to the plurality of rails;
the locking mechanism having a deactivation mechanism;
wherein the deactivation mechanism causes the locking mechanism of the slider box to be disengaged to allow for sliding of the slider box relative to the plurality of rails.

2. The system of claim 1, further comprising:
the framing system of the slider box extending the length from the first end to the second end with opposing sides;
the slider box having a plurality of cross-supports;
the cross-supports extending a length between the opposing sides;
the slider box having a plurality of diagonal cross-supports.

3. The system of claim 1, further comprising:
the slider box having a plurality of apertures;
at least one retractable pin;
wherein the locking mechanism causes the at least one retractable pin to engage in at least one of the plurality of apertures, thereby, preventing sliding of the slider box.

4. The system of claim 1, further comprising:
the locking mechanism operably connected to a handle;
the locking mechanism operably connected to a lever.

5. The system of claim 1, further comprising:
an automated system;
the automated system configured to control the locking mechanism;
wherein the automated system can be controlled remotely.

6. The system of claim 1, further comprising:
the plurality of rails having rail guides;
the plurality of rails having rail clips;
the plurality of rails having a friction surface;
the friction surface having a friction strip;
wherein the friction strip is formed of a material having a low coefficient of friction so that the two surfaces can slide against each other.

7. The system of claim 1, further comprising:
a suspension system;
the suspension system having a plurality of hangers;
wherein the hangers structurally secure the suspension system to the framing system of the slider box.

8. The system of claim 1, further comprising:
a plurality of wheels;
wherein the wheels engage a surface so the slider box system can move from a first location to a second location.

9. The system of claim 1, further comprising:
a plurality of reinforcement plates;
where the plurality of reinforcement plates add structural stability to the framing system.

10. The system of claim 1, further comprising:
each of the plurality of rollers having a bearing.

11. The system of claim 1, further comprising:
wherein the rollers provide operable assistance for a reduced coefficient of friction between the plurality of rails and the slider box.

12. An improved slider box system, comprising:
a trailer;
the trailer having a structural frame;
the structural frame having a plurality of rails;
a slider box;
the slider box having a framing system extending a length from a first end to a second end with opposing sides;
the slider box having a plurality of rail guides;
the slider box having a plurality of cross-supports;
the slider box having a plurality of pin apertures;
at least one retractable pin;
a locking mechanism;
wherein the locking mechanism engages and disengages the at least one retractable pin;
wherein the at least one retractable pin is engaged when the pin slides into at least one of the plurality of pin apertures of the slider box;
wherein the at least one retractable pin is disengaged when the pin slides out of the at least one of the plurality of pin apertures of the slider box;
a plurality of rollers;
the plurality of rollers attached to the slider box;
each of the plurality of rollers having a bearing;
wherein the plurality of rollers engage the plurality of rails such that the plurality of rollers cause the rails to slide more efficiently across the slider box.

13. The system of claim 12, further comprising:
the plurality of rails having a friction surface when engaged with the slider box;
the friction surface having a friction strip;
wherein the friction strip is formed of a material having a low coefficient of friction so that the two surfaces can slide against each other.

14. The system of claim 12, further comprising:
the slider box having a plurality of rail clips.

15. The system of claim 12, further comprising:
the slider box having a plurality of diagonal cross-supports;
the slider box having a plurality of reinforcement plates.

16. The system of claim 12, further comprising:
an automated system for engagement and disengagement of the at least one retractable pin;
the automated system is configured to control engagement and disengagement of the at least one retractable pin;
the automated system having an engagement mechanism operably connected to the at least one retractable pin;
the automated system having a disengagement mechanism operably connected to the at least one retractable pin;
wherein the automated system communicates electronically with a control system;
wherein the at least one retractable pin can be engaged and disengaged remotely.

17. The system of claim 12, further comprising:
a suspension system;
the suspension system having a plurality of hangers;
wherein the hangers structurally secure the suspension system to the framing system of the slider box.

18. The system of claim 12, further comprising:
a plurality of wheels;
wherein the wheels engage a surface so the slider box system can move.

19. A method of redistribution of a load, comprising:
providing a slider box assembly having a framing system;
providing a plurality of rails which engage the slider box;
providing a locking mechanism wherein the locking mechanism engages and disengages the plurality of rails such that the plurality of rails are caused to lock in position relative to the slider box and unlock in position relative to the slider box;
attaching a plurality of rollers to the slider box framing system such that the plurality of rollers operably engage the plurality of rails while still allowing the plurality of rails to be in contact with the slider box;
disengaging a retractable pin so that the plurality of rails can move relative to the slider box, the plurality of rails rolling along the plurality of rollers and sliding across the slider box, reallocating a load;
engaging a retractable pin so that the plurality of rails lock in place relative to the slider box.

20. The method of claim 19, further comprising:
providing a plurality of rails which are attached to a trailer;
providing the locking mechanism having an automated control operably connected to the locking mechanism such that the locking mechanism can be controlled remotely;
adding a frictional strip to the slider box at the point of engagement where the plurality of rails engages the slider box.
